(19) United States
(12) Patent Application Publication
(10) Pub. No.: US 2010/0322460 A1
(43) Pub. Date: Dec. 23, 2010

(54) MAGNETIC CIRCUIT AND AUDIO EQUIPMENT

(75) Inventors: Masahiko Miyazaki, Osaka (JP); Shinji Murakami, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 12/865,011

(22) PCT Filed: Jan. 16, 2009
(86) PCT No.: PCT/JP2009/050572

§ 371 Date: Jul. 28, 2010

(30) Foreign Application Priority Data
Jan. 28, 2008 (JP) 2008-016511

(51) Int. Cl. H04R 11/02; H01F 7/20; H01F 7/02

(52) U.S. Cl. 381/412; 335/209

(57) ABSTRACT

[Problem] To provide a magnetic circuit whose size and thickness can be reduced, and which can generate a high sound pressure by a simple structure.

[Means for Resolution] A magnetic circuit of the present invention includes a horizontal coil wound in a horizontal direction, and an unitary magnet opposed face-to-face to the horizontal coil, wherein the magnet has a first polarity portion and a second polarity portion located adjacent to the first polarity portion. The first polarity portion and the second polarity portion are magnetized mutually in an opposite direction in a direction of a center axis of the horizontal coil, and the second polarity portion is arranged between one area of the first polarity portion and other area of the first polarity portion in a horizontal plane of the magnet.

### TECHNICAL FIELD

The present invention relates to a magnetic circuit capable of showing a high sound pressure performance by a small and slim structure. Also, the present invention relates to an audio-equipment that is equipped with such magnetic circuit and is easy to manufacture at a low cost.

### BACKGROUND ART

A reduction in size and thickness of a personal digital assistant such as a cellular phone advances rapidly, and also needs for a reduction in size and thickness are enhanced in an audio equipment such as a speaker employed in the personal digital assistant. A sectional view of a slim speaker in the background art is illustrated in FIG. 5 (see Patent Literature 1). As shown in FIG. 5, this slim speaker has a diaphragm 52, a magnet 53, and a horizontal coil 54 in the inside of a frame 50 in which sound emitting holes 51 are opened. An outer peripheral portion of the diaphragm 52 is secured to the frame 50. The horizontal coil 54 is arranged in a center portion of the diaphragm 52, and a center axis T of the horizontal coil 54 is aligned perpendicularly to the diaphragm 52. The circular disk type magnet 53 is arranged coaxially with the center axis T of the horizontal coil 54, and is magnetized in the direction parallel to the center axis T. An air gap G is provided between the circular disk type magnet 53 and the horizontal coil 54.

In the slim speaker in shown in FIG. 5, magnetic fluxes M (each indicated with a broken line arrow) are radiated form the magnet 53, and the magnetic fluxes M act on the coil 54 through the air gap G. Thus, when an electric current supplied to the coil 54 is changed, the diaphragm 52 is driven to vibrate. Since the coil 54 is has a flat shape in which the number of laminations in the horizontal direction that intersects orthogonally with the center axis T is larger than the number of laminations in the direction of the center axis T, the slimming down can be achieved in the speaker shown in FIG. 5. However, since this speaker employs a single magnet that is magnetized in one direction, such a problem exists that the sound pressure performance is lowered according to the reduction in size and thickness.

A sectional view of a slim speaker in the prior art in another mode is illustrated in FIG. 6. As shown in FIG. 6, this slim speaker has a diaphragm 62, a magnet 63, and a horizontal coil 64 in the inside of a frame 60. An outer peripheral portion of the diaphragm 52 is put between the frame 60 and a cover 65, and is secured thereto. The horizontal coil 64 is secured to the back surface of the diaphragm 62, the horizontal coil 64 is wound flatly along the center axis T, and the center axis T is aligned perpendicularly to the diaphragm 62. The magnet 63 is arranged to face-to-face oppose to the horizontal coil 64, and is magnetized in the direction parallel to the center axis T. The magnet 63 is composed of a pair of outer magnets 63a each shaped into a rectangular parallelepiped, and an inner magnet 63b shaped into a rectangular parallelepiped. Since the horizontal coil 64 is wound flatly, and a reduction in size and thickness of the speaker can be achieved.

Perspective views of a magnet employed in the slim speaker in the prior art are shown in FIG. 7. As shown in FIG. 7 (a), the magnet 63 is composed of a pair of outer magnets 63a, and the inner magnet 63b. The outer magnets 63a and the inner magnet 63b are magnetized in the opposite direction. A state of a magnetic flux that is formed by the magnet is shown in FIG. 8. As shown in FIG. 8(a), the magnetic fluxes formed by the inner magnet 63b and the magnetic fluxes formed by the outer magnets 63a are superposed mutually, so that the magnetic fluxes with high density pass through the coil 64. As a result, a driving force acting on the diaphragm is increased, and a sound pressure can be enhanced.

When such a structure shown in FIG. 7(b) is employed that the surface of the inner magnet 63b is protruded toward the coil side from the surfaces of the outer magnets 63a, the magnetic fluxes shown in FIG. 8 (b) are formed. Thus, the magnetic fluxes of higher density can be acted on the coil 64. However, a magnetic circuit structure that needs an arrangement of a plurality of magnets is high in material cost, and the productivity of the magnetic circuit is lowered. Also, when such a structure is employed that the surface of the inner magnet is protruded toward the coil side from the surfaces of the outer magnets, a shape of the magnet becomes complicated, and the handling of the magnet is required.

Patent Literature 1: Japanese Patent No. 3213521

### DISCLOSURE OF THE INVENTION

### Problems that the Invention is to Solve

It is an object of the present invention to provide a magnetic circuit whose size and thickness can be reduced, and which can generate a high sound pressure by a simple structure. Also, it is another object of the present invention to provide an audio equipment that shows a high sound pressure performance by a small and slim structure, and is easy to manufacture at a low cost.

### Means for Solving the Problems

A magnetic circuit of the present invention comprises a horizontal coil wound in a horizontal direction; and an unitary magnet opposed face-to-face to the horizontal coil; wherein the magnet has a first polarity portion and a second polarity portion located adjacent to the first polarity portion. The first polarity portion and the second polarity portion are magnetized mutually in an opposite direction in a direction of a center axis of the horizontal coil, and the second polarity portion is arranged between one area of the first polarity portion and other area of the first polarity portion in a horizontal plane of the magnet. Such a mode is preferable that the second polarity portion is surrounded with the first polarity portion in the horizontal plane of the magnet, or such a mode is preferable that the second polarity portion is put between a plurality of first polarity portions in the horizontal plane of the magnet.

Such a mode is preferable that at least a part of horizontal coil should be arranged on the boundary between the first polarity portion and the second polarity portion of the magnet. In particular, such a mode is more preferable that at least a part of center portion between an outer periphery and an inner periphery of the horizontal coil should be arranged on the boundary between the first polarity portion and the second polarity portion of the magnet. Also, such a mode is preferable that the magnet should have the ferromagnetic plate on both surfaces or a single surface of the horizontal plane.

An audio equipment of the present invention includes a magnetic circuit; and a diaphragm; the magnetic circuit has a horizontal coil that is wound in a horizontal direction, and a single magnet face-to-face opposed to the horizontal coil. The magnet has a first polarity portion and a second polarity portion located adjacent to the first polarity portion, the first polarity portion and the second polarity portion are magnetized mutually in an opposite direction in a direction of a center axis of the horizontal coil, and the second polarity portion is arranged between one area of the first polarity portion and other area of the first polarity portion in a horizontal plane of the magnet. The horizontal coil or the magnet are fixed to the diaphragm, and the diaphragm is vibrated by acting magnetic fluxes of the magnet on the horizontal coil to apply an electric current to the horizontal coil.

### ADVANTAGE OF THE INVENTION

The magnetic circuit whose structure is simply, which is small in size and slim in thickness, and whose sound pressure performance is high can be provided.

### BEST MODE FOR CARRYING OUT THE INVENTION

### Magnetic Circuit

### First Embodiment

A structure of a magnetic circuit according to a first embodiment of the present invention is shown in FIG. 1. FIG. 1 (a) is a plan view and a sectional view taken along IB-IB is FIG. 1 (b). FIG. 1(c) is a view showing schematically the magnetic fluxes formed by a magnet. As shown in FIG. 1 (a), this magnetic circuit consists of a horizontal coil 4 and a magnet 3. As shown in FIG. 1 (b), the horizontal coil 4 is face-to-face opposed to the magnet 3, and the magnet 3 is composed of an unitary plate member. In the present embodiment, the plate-like magnet 3 is employed. But the magnet 3 in the present invention is not limited to the plate member, and it is effective to employ a cubic magnet, a rectangular parallelepiped magnet, or the like, for example. This is true of other embodiments. The magnet 3 has a first polarity portion 3a and a second polarity portion 3b located adjacent to the first polarity portion 3a. As shown in FIG. 1 (a), the second polarity portion 3b is arranged between one area A1 of the first polarity portion 3a and other area A2 of the first polarity portion 3a in the horizontal plane of the magnet 3. In an example shown in FIG. 1, as shown in FIG. 1 (a), the magnet 3 has such a structure that the second polarity portion 3b is surrounded with the first polarity portion 3a in the horizontal plane of the magnet 3. Also, the first polarity portion 3a and the second polarity portion 3b are magnetized in the opposite direction in the direction of the center axis of the horizontal coil 4. In the example shown in FIG. 1, the first polarity portion 3a is magnetized such that the upper surface becomes the S-pole in the direction of the center axis of the horizontal coil 4, and the second polarity portion 3b is magnetized such that the upper surface becomes the N-pole in the direction of the center axis of the horizontal coil 4. The similar advantage can be achieved even when the N-pole and the S—pole are magnetized oppositely.

Since the first polarity portion 3a is magnetized in the direction of the center axis of the horizontal coil 4, magnetic fluxes Y11, Y12 are formed by the first polarity portion 3a, as shown in FIG. 1(c). The second polarity portion 3b is arranged adjacent to the first polarity portion 3a, and the second polarity portion 3b is arranged between the first polarity portions 3a. Also, since the second polarity portion 3b is magnetized in the direction of the center axis of the horizontal coil 4 and the direction of its magnetization is opposite to the first polarity portion 3a, magnetic fluxes Z1 are formed by the second polarity portion 3b, as shown in FIG. 1(c). As a result, as shown in FIG. 1(c), the magnetic fluxes Y12 formed by the first polarity portions 3a and the magnetic fluxes Z1 formed by the second polarity portion 3b are superposed mutually in the horizontal coil 4, and thus a magnetic flux density acting on the horizontal coil 4 in the horizontal direction is increased, so that a sound pressure performance can be enhanced.

The magnetic circuit in the present embodiment is constructed by a single magnet. Therefore, a structure of this magnetic circuit is simple rather than the conventional magnetic circuit constructed by a plurality of magnets, a material cost can be reduced, and the productivity can be enhanced. Also, the first polarity portion and the second polarity portion that are magnetized in the opposite direction mutually are provided to the unitary magnet. Therefore, a sound pressure performance can be enhanced rather than the conventional magnetic circuit constructed by a unitary magnet that is magnetized on one direction. Further, the magnetic circuit is constructed by the flat horizontal coil that is wound in the horizontal direction, and the magnet. Therefore, the small and slim magnetic circuit can be provided.

In the example shown in FIG. 1 (a), the horizontal coil 4 is wound concentrically in the horizontal direction, but the horizontal coil is not limited to the circular shape. The horizontal coil that is wounded in a polygonal shape such as a quadrangular shape, a hexagonal shape, or the like can be employed effectively to fit in with shapes of the first polarity portion and the second polarity portion in the magnet or meet the requested needs. In FIG. 12, a planar shape of the horizontal coil is shown. FIG. 12 (a) shows an example of the horizontal coil that is wound like a circle, similarly to FIG. 1 (a). FIG. 12 (b) to FIG. 12 (e) show an example of the horizontal coil that is wound longer in one direction respectively, wherein FIG. 12 (b) shows a quadrangular shape, FIG. 12 (c) shows an elliptic shape, FIG. 12 (d) shows a track shape, and FIG. 12 (e) shows a hexagonal shape. In the present specification, the center axis of the horizontal coil denotes an axis that passes through a center of gravity C of the horizontal coil in a horizontal plane and intersects orthogonally with the horizontal plane.

### Second Embodiment

A structure of a magnetic circuit according to a second embodiment of the present invention is shown in FIG. 2. FIG. 2 (a) is a plan view and a sectional view taken along IIB-IIB is FIG. 2 (b). FIG. 2 (c) is a view showing schematically the magnetic fluxes formed by the magnet. As shown in FIG. 2 (a), this magnetic circuit is composed of the horizontal coil 4 and the magnet 3. As shown in FIG. 2 (b), the horizontal coil 4 is face-to-face opposed to the magnet 3, and the magnet 3 is formed of a unitary plate member. The magnet 3 has the first polarity portion 3a and the second polarity portion 3b located adjacent to the first polarity portion 3a. As shown in FIG. 2 (a), the second polarity portion 3b is arranged between one area A1 of the first polarity portion 3a and other area A2 of the first polarity portion 3a in the horizontal plane of the magnet 3. In an example shown in FIG. 2, as shown in FIG. 2 (a), the magnet 3 has such a structure that the second polarity portion 3b is surrounded with the first polarity portion 3a in the horizontal plate of the magnet 3. Also, the first polarity portion 3a and the second polarity portion 3b are magnetized in the opposite direction in the direction of the center axis of the horizontal coil 4. Also, the magnet 3 has a ferromagnetic plate 5 as a plate member made of ferromagnetic material such as iron, Permalloy, or the like on the bottom surface of the horizontal plane.

Therefore, as shown in FIG. 2 (c), magnetic fluxes Y21, Y21 that the first polarity portion 3a emits and magnetic fluxes Z2 that the second polarity portion 3b emits are caused to pass through the ferromagnetic plate 5. Accordingly, since the magnetic fluxes are attracted toward the horizontal coil 4, the magnetic flux density acting on the horizontal coil 4 in the horizontal direction is enhanced and thus the sound pressure performance can be enhanced. Also, since the ferromagnetic plate 5 is formed on the bottom surface of the magnet 3, demagnetization of the magnet 3 can be suppressed. The magnetic flux densities of the magnetic fluxes Y22 that the first polarity portion 3a emits and the magnetic fluxes Z2 that the second polarity portion 3b emits in the horizontal direction become maximum on the boundary between the first polarity portion 3a and the second polarity portion 3b. Therefore, from a viewpoint that a sound pressure performance should be enhanced by increasing the magnetic flux density acting on the horizontal coil 4 in the horizontal direction, such a mode is preferable that at least a part of horizontal coil 4 should be arranged on the boundary between the first polarity portion 3a and the second polarity portion 3b of the magnet 3. In particular, from a viewpoint that the magnetic flux density in the horizontal direction should become maximum in a center portion 4c in the winding existing area of the horizontal coil 4 that is wound in the horizontal direction, such a mode is preferable that at least a part of center portion 4c between an outer periphery 4a and an inner periphery 4b of the horizontal coil 4 should be arranged on the boundary between the first polarity portion 3a and the second polarity portion 3b of the magnet 3.

In the present embodiment, like the first embodiment, the magnetic fluxes Y22 formed by the first polarity portion 3a and the magnetic fluxes Z2 formed by the second polarity portion 3b are superposed mutually in the horizontal coil 4, and the magnetic flux density acting on the horizontal coil 4 in the horizontal direction is increased. Therefore, the sound pressure performance can be enhanced. Also, the magnetic circuit is constructed by a unitary magnet. Therefore, a structure of this magnetic circuit is simple, a material cost can be reduced, and the productivity can be enhanced. Also, the sound pressure performance is increased rather than the conventional magnetic circuit that is constructed by a unitary magnet that is magnetized in one direction. Also, the magnetic circuit is constructed by the flat horizontal coil that is wound in the horizontal direction, and the magnet. Therefore, the small and slim magnetic circuit can be provided.

### Third Embodiment

A structure of a magnetic circuit according to a third embodiment of the present invention is shown in FIG. 3. FIG. 3 (a) is a plan view and a sectional view taken along IIIB-IIIB is FIG. 3 (b). FIG. 3(c) is a view showing schematically the magnetic fluxes formed by the magnet. As shown in FIG. 3 (a), this magnetic circuit is constructed by the horizontal coil 4, and the magnet 3. As shown in FIG. 3 (b), the horizontal coil 4 is face-to-face opposed to the magnet 3, and the magnet 3 is a unitary plate member. The magnet 3 has the first polarity portion 3a and the second polarity portion 3b located adjacent to the first polarity portion 3a. As shown in FIG. 3 (a), the second polarity portion 3b is arranged between one area A1 of the first polarity portion 3a and other area A2 of the first polarity portion 3a in the horizontal plane of the magnet 3. In an example shown in FIG. 3, as shown in FIG. 3(a), the magnet 3 has such a structure that the second polarity portion 3b is surrounded with the first polarity portion 3a in the horizontal plate of the magnet 3. In the example shown in FIG. 3, from a viewpoint that a structure of a magnetized yoke can be made simple, it is preferable that such a mode should be employed that the magnetic circuit is magnetized linearly. The first polarity portion 3a and the second polarity portion 3b are magnetized in the opposite direction mutually in the direction of the center axis of the horizontal coil 4. Also, the magnet 3 has the ferromagnetic plate 5 made of iron, Permalloy, or the like on the bottom.

The magnetic flux densities of magnetic fluxes Y32 that the first polarity portion 3a emits and magnetic flux Z3 that the second polarity portion 3b emits in the horizontal direction become maximum on the boundary between the first polarity portion 3a and the second polarity portion 3b. Therefore, from a viewpoint that the sound pressure performance should be enhanced by increasing the magnetic flux density acting on the horizontal coil 4 in the horizontal direction, such a mode is preferable that at least a part of horizontal coil 4 should be arranged on the boundary between the first polarity portion 3a and the second polarity portion 3b of the magnet. In particular, from a viewpoint that the magnetic flux density in the horizontal direction become maximum in the center portion 4c of the winding existing area of the horizontal coil 4 that is wound in the horizontal direction, such a mode is preferable that at least a part of center portion 4c between the outer periphery 4a and the inner periphery 4b of the horizontal coil 4 should be arranged on the boundary between the first polarity portion 3a and the second polarity portion 3b of the magnet 3.

In the present embodiment, like the first embodiment, the magnetic fluxes formed by the first polarity portion 3a and the magnetic fluxes formed by the second polarity portion 3b are superposed mutually in the horizontal coil 4. Therefore, the sound pressure performance can be enhanced. Also, the magnetic circuit is constructed by a unitary magnet. Therefore, the structure is made simple, a material cost can be reduced, and the productivity can be enhanced. Also, the sound pressure performance can be improved rather than the conventional magnetic circuit constructed by a unitary magnet that is magnetized in one direction. Also, the magnetic circuit is constructed by the flat horizontal coil that is wound in the horizontal direction, and the magnet. Therefore, the small and slim magnetic circuit can be provided. Also, like the second embodiment, the sound pressure performance can be enhanced by providing the ferroelectric plate on the bottom surface of the magnet, and demagnetization of the magnet can be suppressed.

### Fourth Embodiment

A structure of a magnetic circuit according to a fourth embodiment of the present invention is shown in FIG. 4. FIG. 4 (a) is a plan view and a sectional view taken along IVB-IVB is FIG. 4 (b). FIG. 4 (c) is a view showing schematically the magnetic fluxes formed by the magnet. As shown in FIG. 4 (a), this magnetic circuit is composed of the horizontal coil 4 and the magnet 3. As shown in FIG. 4 (b), the horizontal coil 4 is face-to-face opposed to the magnet 3, and the magnet 3 is formed of a unitary plate member. The magnet 3 has the first polarity portion 3a, and the second polarity portion 3b located adjacent to the first polarity portion 3a. As shown in FIG. 4 (a), the second polarity portion 3b is arranged between one area A1 of the first polarity portion 3a and other area A2 the first polarity portion 3a in the horizontal plate of the magnet 3. The first polarity portion 3a and the second polarity portion 3b are magnetized mutually in the opposite direction in the direction of the center axis of the horizontal coil 4. Also, the magnet 3 has the ferromagnetic plate 5 on the bottom surface in the horizontal plane, and has a ferromagnetic plate 6 on the upper surface.

When the ferromagnetic plate 6 made of iron, Permalloy, or the like is formed on the upper surface of the magnet 3, the magnetic fluxes passing through the ferromagnetic plate 6 are formed as shown in FIG. 4(c), and the ferromagnetic plate 6 attracts magnetic fluxes Y42, Z4. Therefore, the magnetic flux density acting on the horizontal coil 4 in the horizontal direction is increased, and the sound pressure performance can be enhanced. In the present embodiment, like the first embodiment, the magnetic fluxes formed by the first polarity portion 3a and the second polarity portion 3b are superposed mutually in the horizontal coil 4. Therefore, the sound pressure performance becomes high. Also, the magnetic circuit is constructed by a unitary magnet. Therefore, a structure is simple, and the sound pressure performance can be improved rather than the conventional magnetic circuit made of a unitary magnet that is magnetized in one direction. Also, since the magnetic circuit is constructed by the flat horizontal coil and the magnet, the small and slim magnetic circuit can be provided. Also, since the magnetic circuit has the ferromagnetic plate on the bottom surface of the magnet, demagnetization of the magnet can be suppressed.

### Fifth Embodiment

A structure of a magnetic circuit according to a fifth embodiment of the present invention is shown in FIG. 9. FIG. 9 (a) is a plan view, and a sectional view taken along IXB-IXB is FIG. 9 (b), FIG. 9(c) is a view showing schematically the magnetic fluxes formed by the magnet. As shown in FIG. 9 (a), this magnetic circuit is constructed by the horizontal coil 4 and the magnet 3. As shown in FIG. 9 (b), the horizontal coil 4 is face-to-face opposed to the magnet 3, and the magnet 3 is formed of a unitary plate member. The magnet 3 has the first polarity portion 3a, and the second polarity portion 3b located adjacent to the first polarity portion 3a. As shown in FIG. 9 (a), the second polarity portion 3b is arranged between one area A1 of the first polarity portion 3a and other area A2 of the first polarity portion 3a in the horizontal plane of the magnet 3. The first polarity portion 3a and the second polarity portion 3b are magnetized mutually in the opposite direction in the direction of the center axis of the horizontal coil 4. Also, the magnet 3 has the ferromagnetic plate 5 on the bottom surface, and also a ferromagnetic plate 7 on the upper surface.

When the ferromagnetic plate 7 made of iron, Permalloy, or the like is formed on the upper surface of the magnet 3, magnetic fluxes Z9, Y91 passing through the ferromagnetic plate 7 is formed, as shown in FIG. 9 (c), and the ferromagnetic plate 7 attracts magnetic fluxes Y92, Z9. Therefore, the magnetic flux density acting on the horizontal coil 4 in the horizontal direction is increased, and the sound pressure performance can be enhanced. In the present embodiment, like the first embodiment, the magnetic fluxes formed by the first polarity portion 3a and the second polarity portion 3b are superposed mutually in the horizontal coil 4. Therefore, the sound pressure performance becomes high. Also, the magnetic circuit is constructed by a unitary magnet. Therefore, the structure is simple, and the sound pressure performance is improved rather than the conventional magnetic circuit formed of a unitary magnet that is magnetized in one direction. Also, since the magnetic circuit is constructed by the flat horizontal coil and the magnet, a reduction in size and thickness can be easily attained, Like the second embodiment, since the ferromagnetic plate is provided on the bottom surface of the magnet, the sound pressure performance becomes high and demagnetization of the magnet can be suppressed.

### Sixth Embodiment

A structure of a magnetic circuit according to a sixth embodiment of the present invention is shown in FIG. 10. FIG. 10 (a) is a plan view and a sectional view taken along XB-XB is FIG. 10 (b). FIG. 10 (c) is a view showing schematically the magnetic fluxes formed by the magnet. As shown in FIG. 10 (a), this magnetic circuit is constructed by the horizontal coil 4 and the magnet 3. As shown in FIG. 10 (b), the horizontal coil 4 is face-to-face opposed to the magnet 3, and the magnet 3 is a unitary plate member. The magnet 3 has the first polarity portion 3a and the second polarity portion 3b located adjacent to the first polarity portion 3a. As shown in FIG. 10 (a), the second polarity portion 3b is arranged between one area A1 of the first polarity portion 3a and other area A2 of the first polarity portion 3a in the horizontal plane of the magnet 3. The first polarity portion 3a and the second polarity portion 3b are magnetized mutually in the opposite direction in the direction of the center axis of the horizontal coil 4. Also, the magnet 3 has the ferromagnetic plate 5 on the bottom surface, and has further the ferromagnetic plates 6, 7 on the upper surface.

Like the fourth embodiment and the fifth embodiment, when the ferromagnetic plates 6, 7 made of iron, Permalloy, or the like are formed on the upper surface of the magnet 3, magnetic fluxes Z10 passing through the ferromagnetic plates 6, 7 are formed, as shown in FIG. 10(c), and the ferromagnetic plates 6, 7 attract the magnetic fluxes respectively. Therefore, the magnetic flux density acting on the horizontal coil 4 in the horizontal direction is increased, and the sound pressure performance can be enhanced. Also, like the second embodiment, the ferromagnetic plate 5 is provided on the bottom surface of the magnet. Therefore, the sound pressure performance becomes high, and demagnetization of the magnet can be suppressed. In the present embodiment, like the first embodiment, the magnetic fluxes formed by the first polarity portion 3a and the second polarity portion 3b are superposed mutually in the horizontal coil 4. Therefore, the sound pressure performance can be improved. Also, the magnetic circuit is constructed by a unitary magnet. Therefore, the structure becomes simple, and the sound pressure performance can be enhanced rather than the conventional magnetic circuit made of a unitary magnet that is magnetized in one direction. Also, the sound pressure performance is constructed by the flat horizontal coil and the magnet. Therefore, the small and slim magnetic circuit can be provided.

### Seventh Embodiment

A structure of a magnetic circuit according to a seventh embodiment of the present invention is shown in FIG. 11. FIG. 11 (a) is a plan view and a sectional view taken along XIB-XIB is FIG. 11 (b). FIG. 11(c) is a view showing schematically the magnetic fluxes formed by the magnet. As shown in FIG. 11 (a), this magnetic circuit is constructed by the horizontal coil 4 and the magnet 3. As shown in FIG. 11 (b), the horizontal coil 4 is face-to-face opposed to the magnet 3, and the magnet 3 is formed of a unitary plate member. The magnet 3 has the first polarity portion 3a and the second polarity portion 3b located adjacent to the first polarity portion 3a. As shown in FIG. 11 (a), the second polarity portion 3b is arranged between one area A1 of the first polarity portion 3a and other area A2 of the first polarity portion 3a in the horizontal plane of the magnet 3. The first polarity portion 3a and the second polarity portion 3b are magnetized in the opposite direction in the direction of the center axis of the horizontal coil 4. Also, the magnet 3 has the ferromagnetic plate 5 made of iron, Permalloy, or the like on the bottom surface.

As shown in FIG. 11(a), this magnetic circuit has such a structure that two second polarity portions 3b are surrounded with one first polarity portion 3a in the horizontal plane of the magnet 3. Therefore, the layout of the magnetic circuit is made compact intensively, and miniaturization of the magnetic circuit can be facilitated much more. Also, like the second embodiment, this magnetic circuit has the ferromagnetic plate on the bottom surface of the magnet. Therefore, the sound pressure performance can be improved, and demagnetization of the magnet can be suppressed. In the present embodiment, like the first embodiment, the magnetic fluxes formed by the first polarity portion 3a and the second polarity portion 3b are superposed mutually in the horizontal coil 4. Therefore, the sound pressure performance becomes high. Also, the magnetic circuit is constructed by a unitary magnet. Therefore, the structure is made simple, and the sound pressure performance is increased rather than the conventional magnetic circuit formed of a unitary magnet that is magnetized on one direction. Also, the magnetic circuit is constructed by the flat horizontal coil and the magnet. Therefore, a reduction in size and thickness is facilitated.

### Audio Equipment

### Eighth Embodiment

A structure of an audio-equipment according to an eighth embodiment of the present invention is shown in FIG. 13. FIG. 13 (a) and FIG. 13 (a) are perspective views, and a sectional view taken along XIIIC-XIIIC in FIG. 13 (a) is FIG. 13 (c). As illustrated in FIG. 13 (a), this audio equipment has a flat cylindrical frame 8, and a circular-disc cover 10 provided in the opening portion in the front surface of the frame 8. This cover 10 has a plurality of sound emitting holes 9. A circular magnetic circuit as shown in FIG. 1 (a), for example, is installed into the audio equipment shown in FIG. 13 (a). As shown in FIG. 13 (c), the interior of the frame 8 is constructed by the magnetic circuit and a diaphragm 11, and an outer peripheral portion of the diaphragm 11 is fixed to the frame 8. The magnetic circuit is constructed by the horizontal coil 4, and the magnet 3. The horizontal coil 4 is face-to-face opposed to the magnet 3, and the magnet 3 is formed of a unitary plate member. The magnet 3 has the first polarity portion 3a, and the second polarity portion 3b located adjacent to the first polarity portion 3a. The second polarity portion 3b is arranged between one area of the first polarity portion 3a and other area of the first polarity portion 3a in the horizontal plane of the magnet 3. For example, as shown in FIG. 1 (a) or FIG. 2 (a), the magnetic circuit can be constructed such that the second polarity portion 3b is surrounded with the first polarity portion 3a in the horizontal plane of the magnet 3. On the contrary, as shown in FIG. 3 (a), the magnetic circuit can be constructed such that the second polarity portion 3b is surrounded with a plurality of first polarity portions 3a in the horizontal plane of the magnet 3.

The first polarity portion 3a and the second polarity portion 3b are magnetized in the opposite direction in the direction of the center axis of the horizontal coil 4. In FIG. 13 (c), such a mode is illustrated that the horizontal coil 4 and the diaphragm 11 are fixed mutually. But such a mode may be employed that arrangement of the horizontal coil 4 and the magnet 3 is changed, and the magnet 3 is fixed the diaphragm 11, in place of the horizontal coil 4. Such a mode is preferable that at least a part of horizontal coil 4 should be arranged on the boundary between the first polarity portion 3a and the second polarity portion 3b of the magnet 3. Such a mode is more preferable that at least a part of center portion between the outer periphery and the inner periphery of the horizontal coil 4 should be arranged on the boundary between the first polarity portion 3a and the second polarity portion 3b of the magnet 3. Also, such a mode is preferable that the magnet 3 should have the ferromagnetic plate on both surfaces or a single surface of the horizontal plane.

This audio equipment can be used effectively as a speaker or a receiver, for example, by driving the diaphragm when the magnetic fluxes of the magnet are caused to act on the horizontal coil 4 by applying an electric current to the horizontal coil 4. The audio equipment shown in FIG. 13 (b) is equipped with the flat cylindrical frame 8 having a long, narrow or elliptic planar shape, and the long, narrow or elliptic cover 10 provided in the opening portion in the front surface of the frame 8. This cover 10 has a plurality of sound emitting holes 9. The long, narrow or elliptic magnetic circuit shown in FIG. 11 (a), for example, can be installed into such audio equipment. Like the first embodiment, the magnetic fluxes formed by the first polarity portion 3a and the second polarity portion 3b are superposed mutually in the horizontal coil 4. Therefore, the sound pressure performance becomes high. Also, the magnetic circuit is constructed by a unitary magnet. Therefore, the structure is simple, and the sound pressure performance is increased rather than the conventional magnetic circuit constructed by a unitary magnet that is magnetized in one direction. Also, the magnetic circuit is constructed by the flat horizontal coil, and the magnet. Therefore, the small and slim structure can be provided. As a result, this audio equipment is useful as the audio equipment such as the cellular phone, or the like.

### INDUSTRIAL APPLICABILITY

The audio equipment showing the high sound pressure performance and having the small and slim structure can be provided. This audio equipment is easy to manufacture at a low cost.

### BRIEF DESCRIPTION OF THE DRAWINGS

FIG. 1 Views showing a structure of a magnetic circuit according to a first embodiment of the present invention respectively.

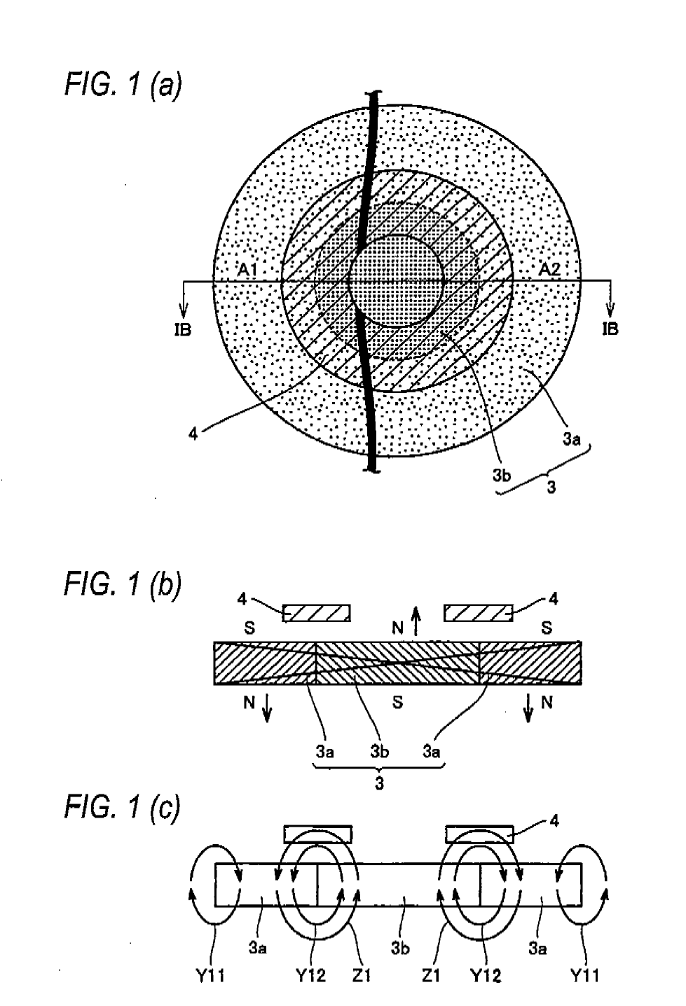

FIG. 2 Views showing a structure of a magnetic circuit according to a second embodiment of the present invention respectively.

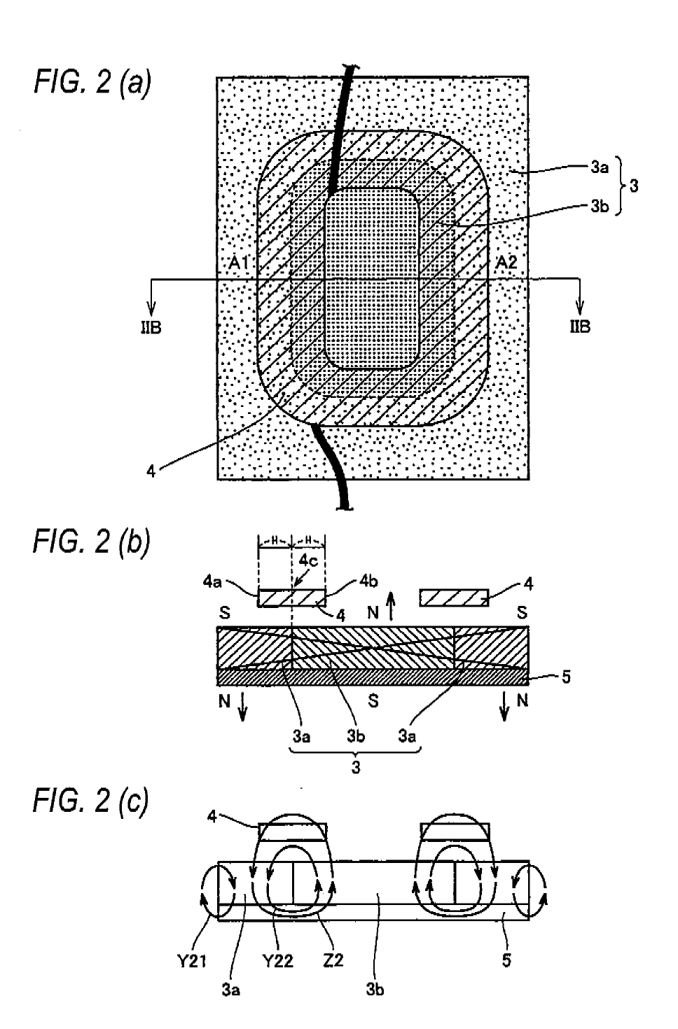

FIG. 3 Views showing a structure of a magnetic circuit according to a third embodiment of the present invention respectively.

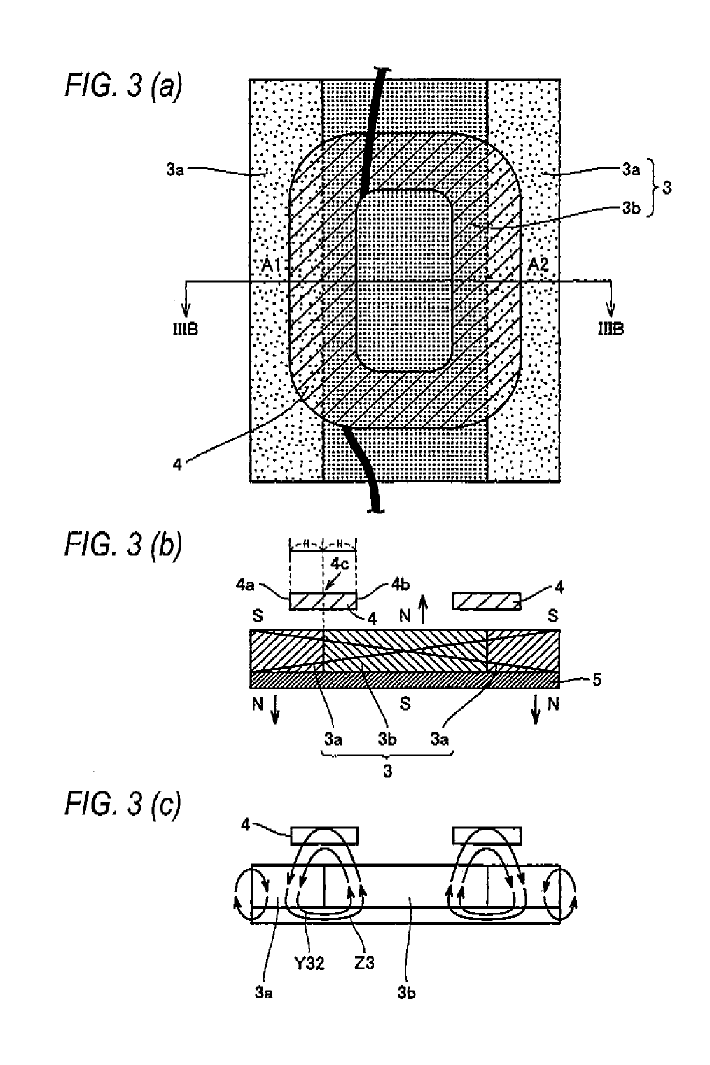

FIG. 4 Views showing a structure of a magnetic circuit according to a fourth embodiment of the present invention respectively.

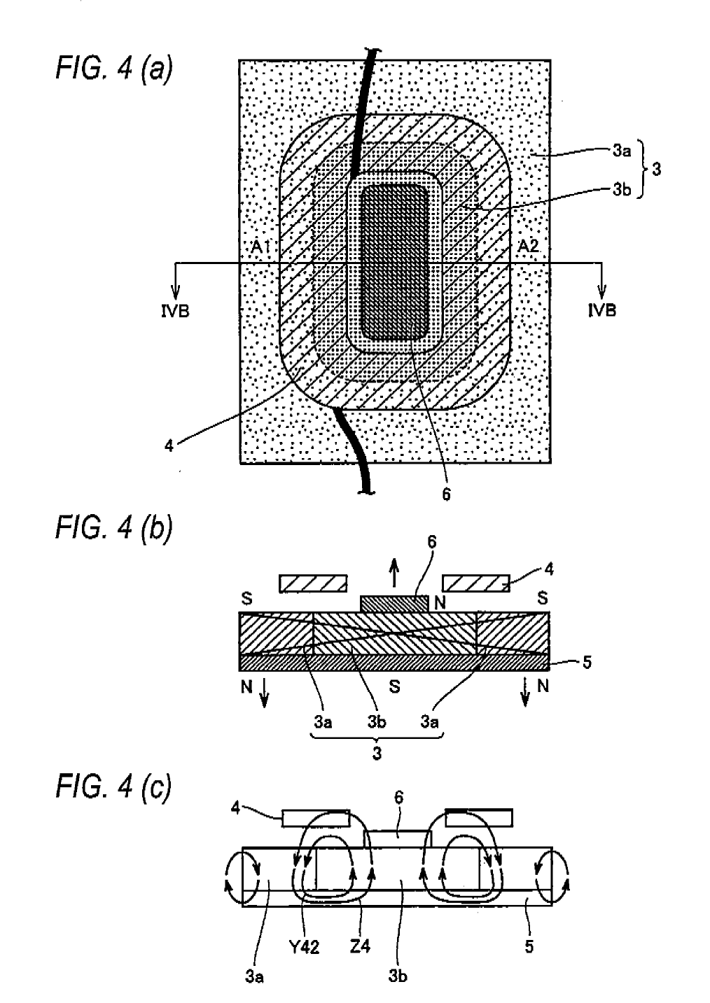

FIG. 5 A sectional view of a slim speaker in the prior art.

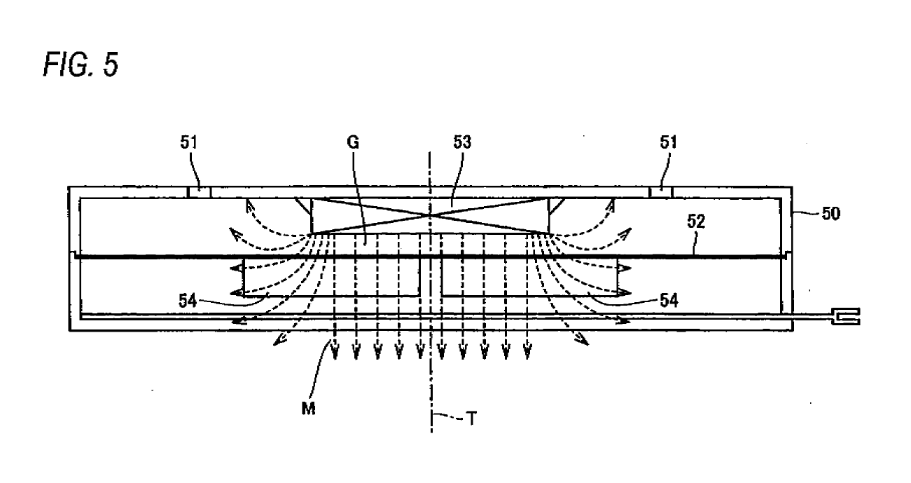

FIG. 6 A sectional view of another slim speaker in the prior art.

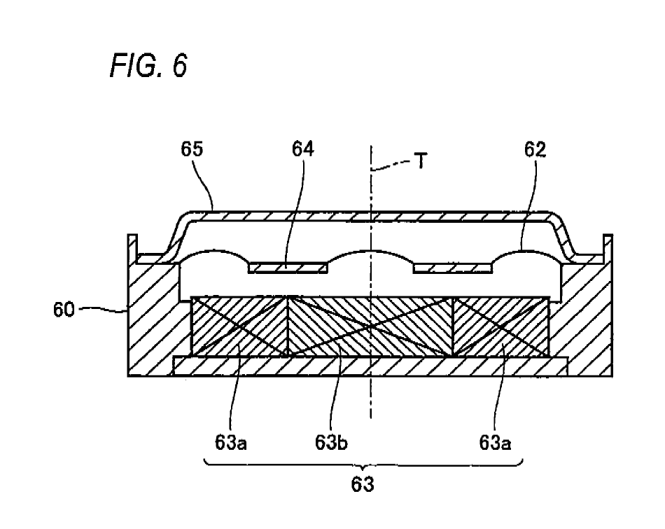

FIG. 7 Perspective views of a magnet employed in the slim speaker in the prior art.

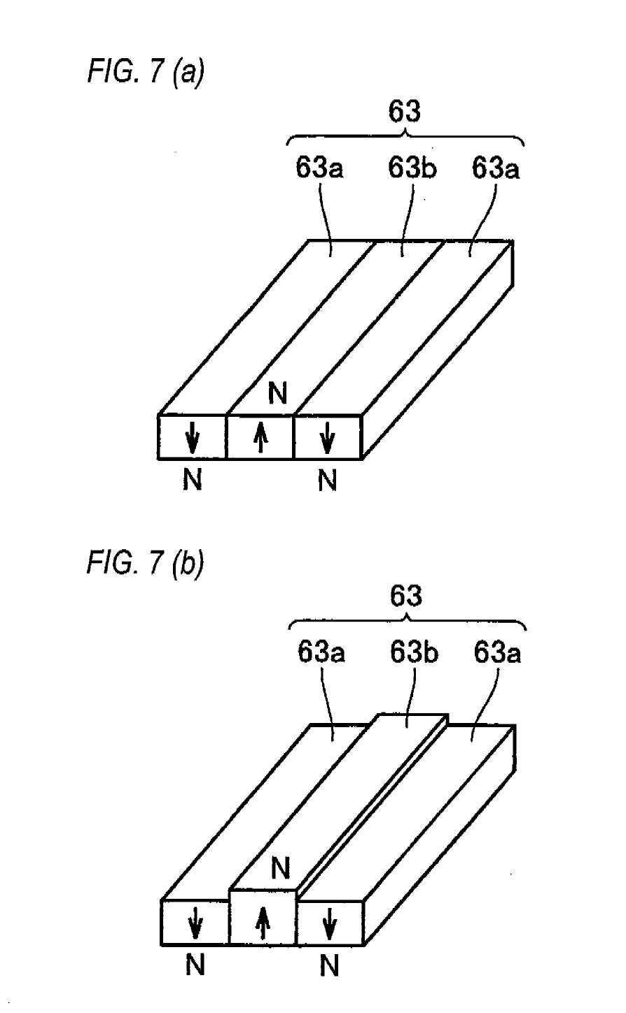

FIG. 8 Views showing a state of a magnetic flux that is formed by the magnet employed in the slim speaker in the prior art.

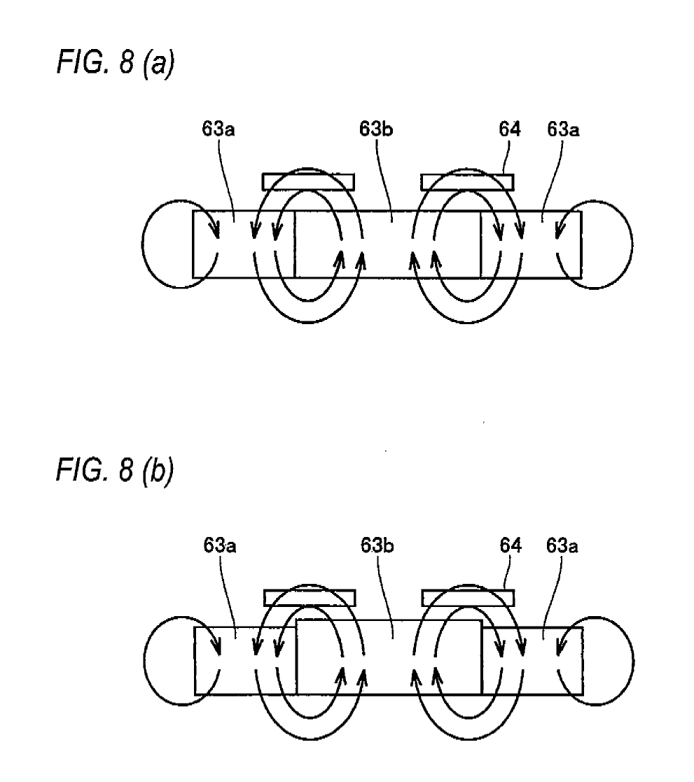

FIG. 9 Views showing a structure of a magnetic circuit according to a fifth embodiment of the present invention respectively.

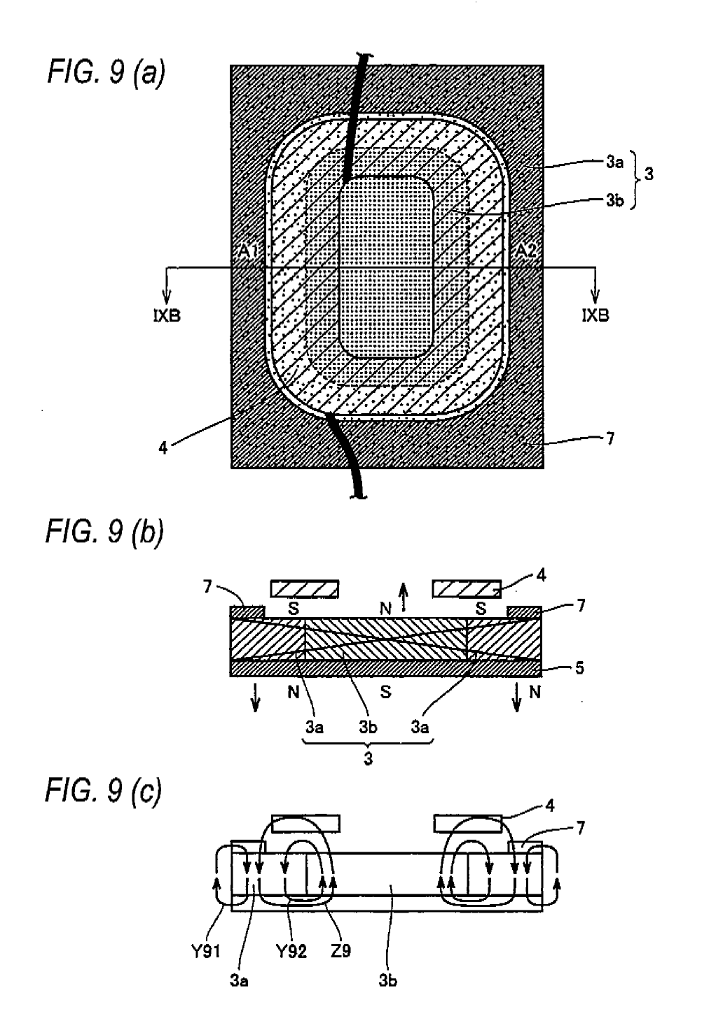

FIG. 10 Views showing a structure of a magnetic circuit according to a sixth embodiment of the present invention respectively.

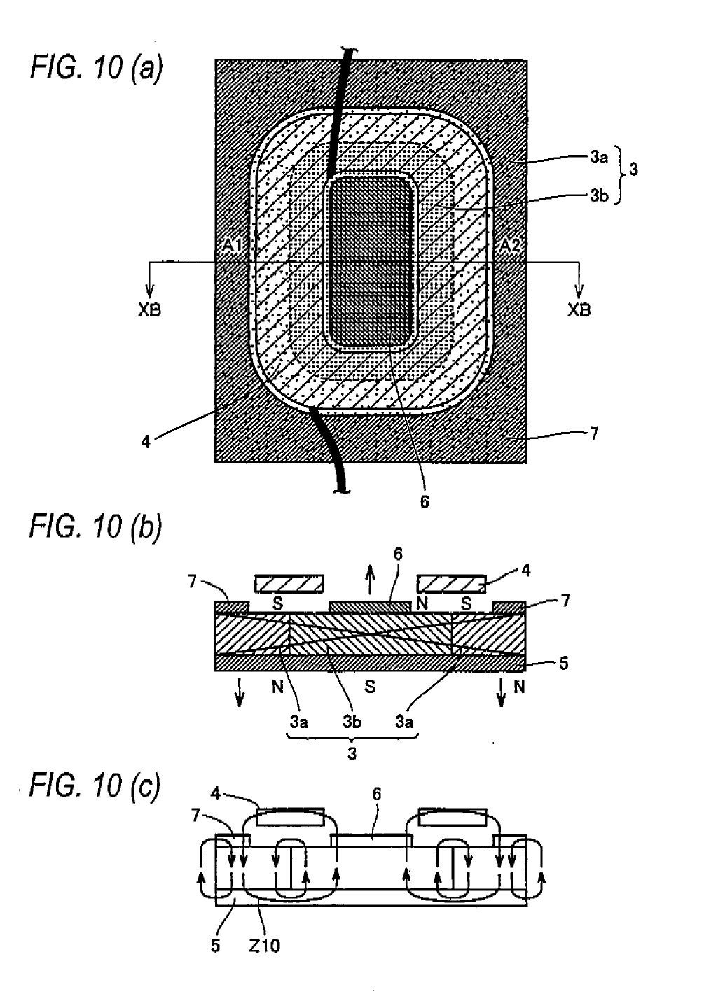

FIG. 11 Views showing a structure of a magnetic circuit according to a seventh embodiment of the present invention respectively,

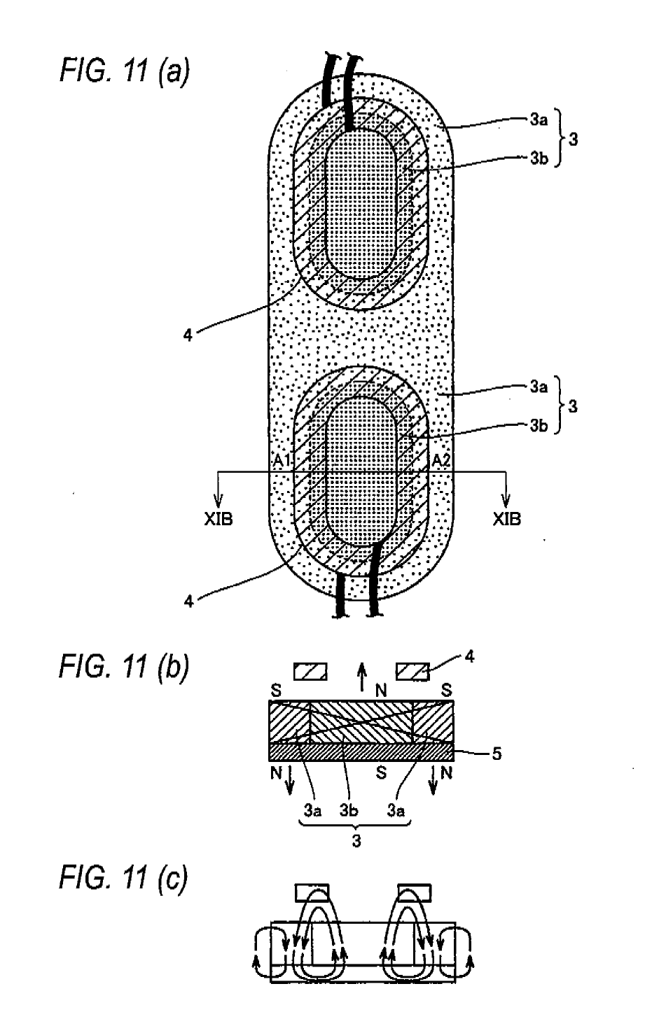

FIG. 12 Views showing a planar shape of a horizontal coil respectively.

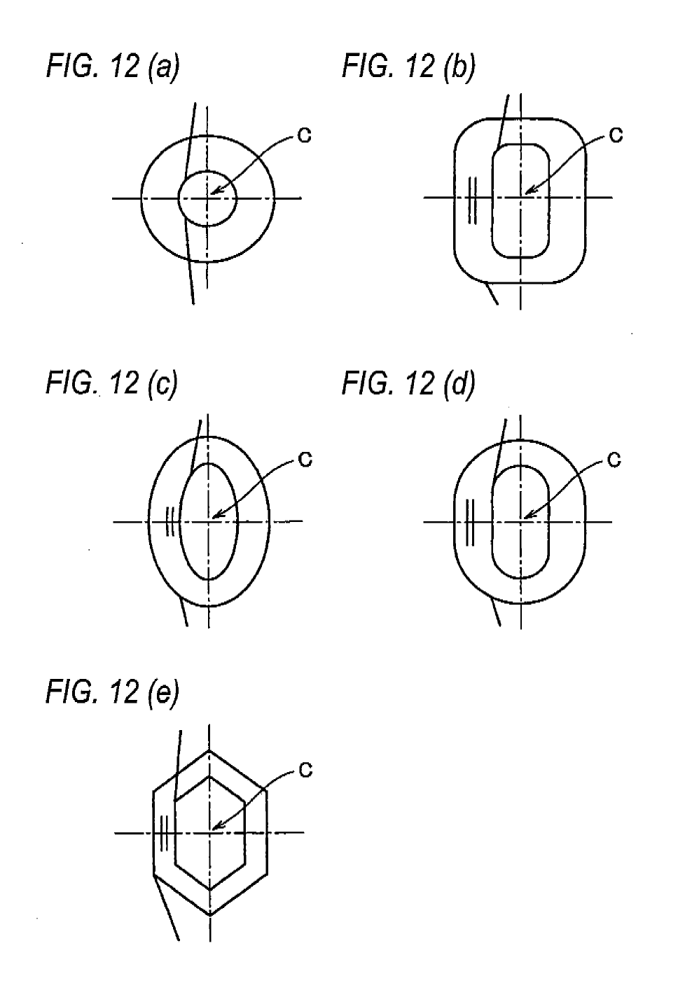

FIG. 13 Views showing a structure of an audio equipment according to an eighth embodiment of the present invention respectively.

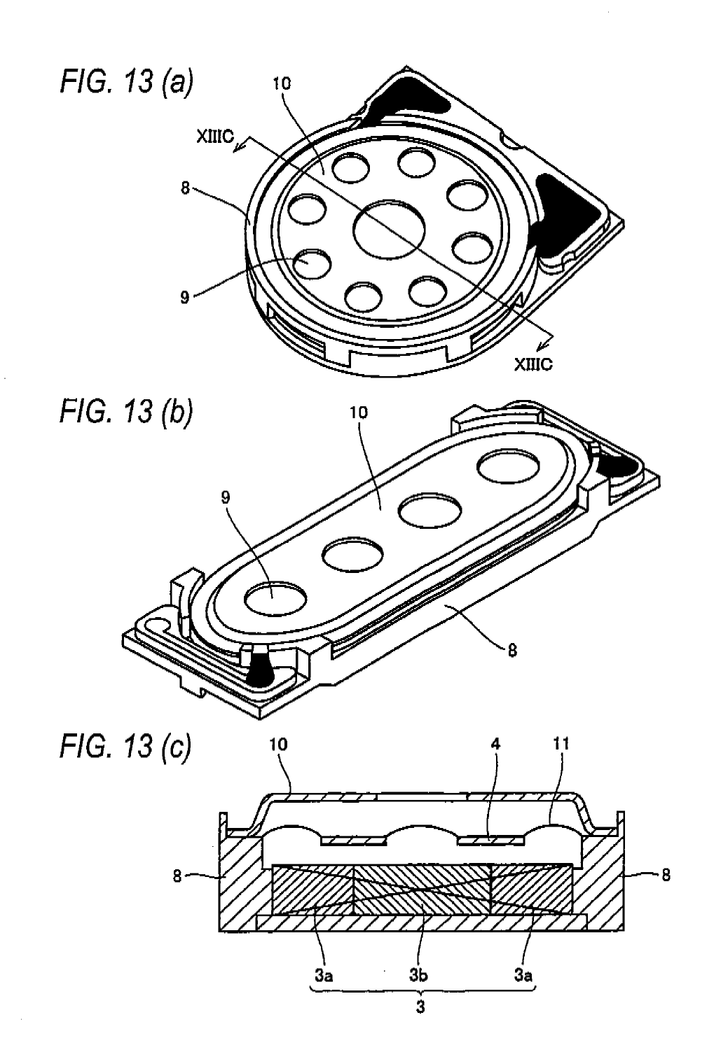

### DESCRIPTION OF REFERENCE NUMERALS

3 magnet, 3a first polarity portion, 3b second polarity portion, 4 horizontal coil, 5, 6, 7 ferromagnetic plate, 8 frame, 9 sound emitting hole, 10 cover, 11 diaphragm.

1. A magnetic circuit, comprising:
a horizontal coil wound in a horizontal direction; and
an unitary magnet that is opposed face-to-face to the horizontal coil;
wherein the magnet has a first polarity portion and a second polarity portion that is located adjacent to the first polarity portion, the first polarity portion and the second polarity portion are magnetized mutually in an opposite direction in a direction of a center axis of the horizontal coil, and the second polarity portion is arranged between one area of the first polarity portion and other area of the first polarity portion in a horizontal plane of the magnet.

2. The magnetic circuit according to claim 1, wherein the second polarity portion is surrounded by the first polarity portion in the horizontal plane of the magnet.

3. The magnetic circuit according to claim 1, wherein the second polarity portion is put between a plurality of first polarity portions in the horizontal plane of the magnet.

4. The magnetic circuit according to claim 1, wherein at least a part of horizontal coil is arranged on a boundary between the first polarity portion and the second polarity portion of the magnet.

5. The magnetic circuit according to claim 1, wherein the horizontal coil is arranged such that at least a part of a center portion between an outer periphery and an inner periphery of the horizontal coil is positioned on the boundary between the first polarity portion and the second polarity portion of the magnet.

6. The magnetic circuit according to claim 1, wherein the magnet has a ferromagnetic plate on both surfaces or one surface of the horizontal plane.

7. An audio equipment comprising:
a magnetic circuit; and
a diaphragm;
the magnetic circuit has a horizontal coil that is wound in a horizontal direction, and an unitary magnet face-to-face opposed to the horizontal coil,
the magnet has a first polarity portion and a second polarity portion located adjacent to the first polarity portion, the first polarity portion and the second polarity portion are magnetized mutually in an opposite direction in a direction of a center axis of the horizontal coil, and the second polarity portion is arranged between one area of the first polarity portion and other area of the first polarity portion in a horizontal plane of the magnet, and
the horizontal coil or the magnet are fixed to the diaphragm, and the diaphragm is vibrated by acting magnetic fluxes of the magnet on the horizontal coil to apply an electric current to the horizontal coil.
